(19) United States
(12) Patent Application Publication
(10) Pub. No.: US 2025/0328104 A1
(43) Pub. Date: Oct. 23, 2025

(54) IMAGE FORMING APPARATUS

(71) Applicant: SHARP KABUSHIKI KAISHA, Sakai City (JP)

(72) Inventor: Kazuya IWASE, Sakai City (JP)

(21) Appl. No.: 19/091,494

(22) Filed: Mar. 26, 2025

(30) Foreign Application Priority Data
Apr. 17, 2024 (JP) 2024-067005

(51) Int. Cl. G03G 21/08; B41J 2/447; G03G 15/04

(52) U.S. Cl. CPC G03G 21/08; B41J 2/447; G03G 15/04045

(57) ABSTRACT

An image forming apparatus includes a photoreceptor drum, and a panel member that faces a photoreceptor drum, and has a plurality of light-emitting elements. The plurality of light-emitting elements includes an image exposure unit that exposes the photoreceptor drum to form an image, and a static eliminator that eliminates static. The static eliminator has a larger area for exposing the photoreceptor drum than the image exposure unit.

This application claims the priority based on Japanese Patent Application No. 2024-067005 filed in Japan on Apr. 17, 2024, the entire contents of which are incorporated into the present application by reference.

### BACKGROUND OF THE INVENTION

### Field of the Invention

The present disclosure relates to an image forming apparatus including a panel member having a plurality of light-emitting elements.

### Description of the Background Art

Conventionally, electrophotographic image forming apparatuses, in which an electrostatic latent image is formed on a photoreceptor by using laser light or the like, and then the electrostatic latent image is developed, transferred, and fixed to form an image on paper, have been widely used. In recent years, a linear light source, in which point light sources such as light-emitting elements are arranged in a line, is often used as light sources for exposing photoreceptors. Furthermore, in the image forming apparatus, a linear light source may be used in a static elimination process, and a method for reducing current consumption in this case is proposed.

The conventional image forming apparatus forms an electrostatic latent image on a photoreceptor by controlling emission of light from a light source device with a plurality of light-emitting elements arranged in a line, and includes an image information acquirer that acquires image information, and one or more light source controllers that control the light emission on the basis of the image information and perform a static elimination process that eliminates electric charges on the photoreceptor, and when the light emission is controlled in the static elimination process, the one or more light source controllers turn off some of the plurality of light-emitting elements and make light emission time in one light emission control longer than light emission time in the light emission control for forming the electrostatic latent image.

In the above image forming apparatus, the light emission time is increased by increase in an exposure light amount, so that an entire surface of the photoreceptor is exposed, but this has a problem that processing time in the static elimination process is increased. Therefore, a different method is required to perform static elimination of the entire photoreceptor surface.

The present disclosure has been made to solve the above problem, and an object of the present disclosure is to provide an image forming apparatus that can eliminate static so as to cover a portion used for image formation.

### SUMMARY OF THE INVENTION

An image forming apparatus according to the present disclosure is an image forming apparatus including a photoreceptor, and a panel member that faces the photoreceptor, and has a plurality of light-emitting elements, wherein the plurality of light-emitting elements includes an image exposure unit that exposes the photoreceptor to form an image, and a static eliminator that eliminates static, and the static eliminator has a larger area for exposing the photoreceptor than the image exposure unit.

In the image forming apparatus according to the present disclosure, the static eliminator may have a longer length in an axial direction along a rotation axis of the photoreceptor than the image exposure unit.

In the image forming apparatus according to the present disclosure, the static eliminator and the image exposure unit may be disposed adjacent to each other in a direction orthogonal to the axial direction.

In the image forming apparatus according to the present disclosure, the panel member may be bent such that a surface on which the image exposure unit is provided intersects with a surface on which the static eliminator is provided.

In the image forming apparatus according to the present disclosure, the static eliminators may be disposed adjacent to both ends in the axial direction of the image exposure unit so as to interpose the image exposure unit therebetween, and the image exposure unit may eliminate static together with the static eliminators.

In the image forming apparatus according to the present disclosure, the image exposure unit may include a plurality of rows of the light-emitting elements arranged adjacent to each other in a direction orthogonal to the axial direction.

According to the present disclosure, together with the image exposure unit, which is a pixel group that forms an image, the static eliminator, which has a larger area for exposing the photoreceptor than the image exposure unit, is provided on the same panel member, and therefore the static eliminator can eliminate static so as to cover a portion used for image formation.

### BRIEF DESCRIPTION OF THE DRAWINGS

FIG. 1 is a schematic sectional view illustrating a configuration of an image forming apparatus according to a first embodiment of the present disclosure.

FIG. 2 is a schematic plan view illustrating a panel member in the first embodiment of the present disclosure.

FIG. 3 is a schematic plan view illustrating a panel member in a second embodiment of the present disclosure.

FIG. 4 is a schematic plan view illustrating a panel member in a third embodiment of the present disclosure.

FIG. 5 is a schematic plan view illustrating a panel member in a fourth embodiment of the present disclosure.

FIG. 6 is a schematic side view illustrating a positional relationship between a photoreceptor drum and a panel member in a fifth embodiment of the present disclosure.

### DESCRIPTION OF THE PREFERRED EMBODIMENTS

### First Embodiment

An image forming apparatus according to a first embodiment of the present disclosure will be hereinafter described with reference to the drawings.

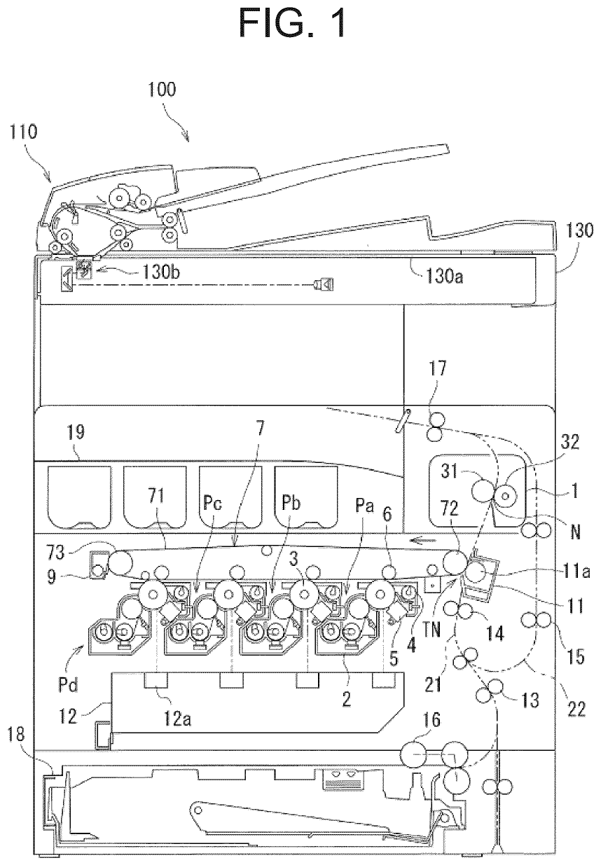

FIG. 1 is a schematic sectional view illustrating a configuration of an image forming apparatus according to a first embodiment of the present disclosure.

An image forming apparatus 100 is a multifunction machine that has a copy function, a scanner function, a facsimile function, and a printer function. An image of a document read by an image reading device 130 is transmitted to an external source, or the image of the document read by the image reading device 130 or an image received from the external source is formed in color or in a single color on a recording medium such as paper.

A document feeding device 110 supported so as to be able to be opened and closed freely is provided above the image reading device 130. The document feeding device 110 transports one or more documents one by one in sequence. The image reading device 130 scans a document placed on a document placement table 130a by scanning with a scanning optical system 130b, or reads a document transported by the document feeding device 110 to generate image data.

The image forming apparatus 100 includes a fixing device 1, developing devices 2, photoreceptor drums 3 (an example of a photoreceptor), drum cleaning devices 4, chargers 5, an intermediate transfer belt device 7, a secondary transfer device 11, an exposure device 12, a paper feeder 18, and the like.

In the image forming apparatus 100, image data corresponding to a color image using each of the colors black (K), cyan (C), magenta (M), and yellow (Y), or a monochrome image using a single color (e.g., black). The image forming apparatus 100 is provided with the four developing devices 2 for forming four types of toner images, the four photoreceptor drums 3, the four drum cleaning devices 4, and the four chargers 5, each corresponding to black, cyan, magenta, and yellow, and forming four image stations Pa, Pb, Pc, and Pd.

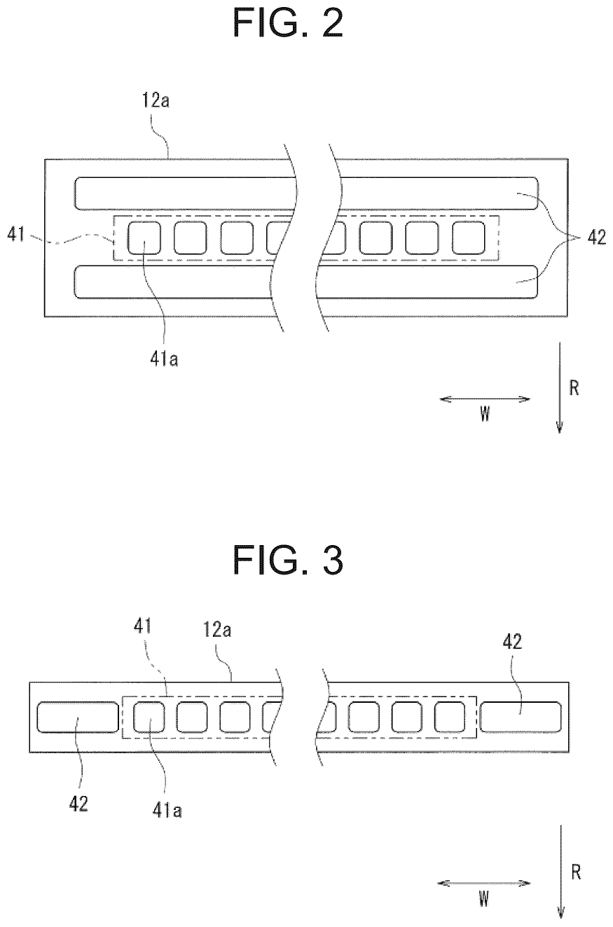

Chargers 5 uniformly charge surfaces of the photoreceptor drums 3 to a predetermined potential. The exposure device 12 has panel members 12a facing the surfaces of the photoreceptor drums 3, and exposes the surfaces of the photoreceptor drums 3 to form electrostatic latent images. In FIG. 1, the panel members 12a are schematically disposed at a predetermined distance from the surfaces of the photoreceptor drums 3. This distance is appropriately set from positions close to the surfaces of the photoreceptor drums 3 to positions far away depending on the resolution of the electrostatic latent images and the amount of light of the panel members 12a. The developing devices 2 develop the electrostatic latent images on the surfaces of the photoreceptor drums 3 to form toner images on the surfaces of the photoreceptor drums 3. The drum cleaning devices 4 eliminate and collect residual toners from the surfaces of the photoreceptor drums 3. Through the above series of operation, a toner image of each color is formed on the surface of each photoreceptor drum 3. The panel members 12a will be described in detail with reference to FIG. 2.

The intermediate transfer belt device 7 includes intermediate transfer rollers 6, an endless intermediate transfer belt 71, an intermediate transfer driving roller 72, an intermediate transfer driven roller 73, and a cleaning device 9. The four intermediate transfer rollers 6 are provided inside the intermediate transfer belt 71 so as to form four toner images corresponding to the respective colors. The intermediate transfer rollers 6 transfer the toner images of the respective colors formed on the surfaces of the photoreceptor drums 3 onto the rotating and moving intermediate transfer belt 71.

The intermediate transfer belt 71 is stretched over the intermediate transfer driving roller 72 and the intermediate transfer driven roller 73. In the image forming apparatus 100, the toner images of the respective colors formed on the surfaces of the photoreceptor drums 3 are transferred and superimposed in sequence to form color toner images on the surface of the intermediate transfer belt 71. The cleaning device 9 eliminates and collects waste toner that is not transferred to paper and remains on the surface of the intermediate transfer belt 71.

The secondary transfer device 11 transports paper transported through a paper transport path 21 by nipping the paper with a transfer nipper TN between a secondary transfer roller 11a and the intermediate transfer belt 71. When the paper passes through the transfer nipper TN, the toner image on the surface of the intermediate transfer belt 71 is transferred to the paper and the paper is transported to the fixing device 1.

The fixing device 1 includes a fixing belt 31 and a pressure roller 32 that rotate around respective axes. The fixing device 1 nips the paper with the transferred toner image with a nipper N between the fixing belt 31 and the pressure roller 32, and applies heat and pressure to fix the toner image to the paper. Although not illustrated in FIG. 1, the fixing device 1 may have components other than the fixing belt 31 and the pressure roller 32.

The paper feeder 18 includes a paper feed cassette that loads a recording medium (paper) used for image formation, and is provided below the exposure device 12. The paper is pulled from the paper feeder 18 by a pickup roller 16 and transported to the paper transport path 21. The paper transported to the paper transport path 21 passes through the secondary transfer device 11 and the fixing device 1, and is ejected into a paper ejection tray 19 by ejection rollers 17.

In the paper transport path 21, transport rollers 13, resist rollers 14, and ejection rollers 17 are disposed. The transport rollers 13 facilitate transport of the paper. The resist rollers 14 transport the paper at a speed equal to a process speed at which an image is formed on the paper. The resist rollers 14 are provided between the paper feeder 18 and the secondary transfer device 11, and adjust the timing of the paper transport such that the toner image is transferred to the paper by the secondary transfer device 11. For example, the resist rollers 14 wait (stop for a moment) while clamping the paper transported from the paper feeder 18, and then start transporting the paper at a constant speed in synchronization with the secondary transfer device 11.

In a case where an image is formed not only on the front side of the paper but on the back side, the paper transport direction is changed by the ejection rollers 17, and the paper is transported to a reversing transport path 22. In the reversing transport path 22, the paper is upside down by reversing transport rollers 15 to be guided to the resist rollers 14. The image forming apparatus 100 forms an image on the back side of the paper guided by the resist rollers 14 in the same manner as on the front side, and ejects the paper into the paper ejection tray 19.

FIG. 2 is a schematic plan view illustrating the panel member in the first embodiment of the present disclosure.

In an image exposure unit 41, the four panel members 12a are provided so as to face the respective four photoreceptor drums 3. The four panel members 12a have substantially the same configuration, and therefore FIG. 2 schematically illustrates only the one panel member 12a.

Each panel member 12a has a plurality of light-emitting elements, and the light-emitting elements compose the image exposure unit 41 that exposes the photoreceptor drum 3 and static eliminators 42 that eliminate static. Although not illustrated, an optical member such as a self-lens may be disposed between the photoreceptor drum 3 and the panel member 12a, and light emitted from the light-emitting elements may form an image on the photoreceptor drum 3. The optical member can be disposed in various ways. For example, optical members can be provided at positions corresponding to the image exposure unit 41 and the static eliminators 42, an optical member can be provided as an integrated optical member corresponding to the image exposure unit 41 and the static eliminators 42, or an optical member can be provided at a position corresponding to only one of the image exposure unit 41 and the static eliminators 42. The image exposure unit 41 forms an electrostatic latent image on the surface of the photoreceptor drum 3 by exposing pixels based on the image data. The static eliminators 42 perform a static elimination process that eliminates charges on the photoreceptor drum 3 by applying light on the surface of the photoreceptor drum 3.

In the image forming apparatus 100, the axial direction W along the rotation axis of the photoreceptor drum 3 is parallel to the width direction of the paper on which an image is formed, and the photoreceptor drum 3 rotates around the rotation axis. The panel member 12a is a rectangular flat plate, the longitudinal direction of the panel member 12a corresponds to the axial direction W, and the transverse direction of the panel member 12a corresponds to the rotation direction R of the photoreceptor drum 3.

In the panel member 12a, the static eliminators 42 and the image exposure unit 41 are disposed adjacent to each other in the direction orthogonal to the axial direction W (rotation direction R). Specifically, the static eliminators 42 are provided at two locations with the image exposure unit 41 disposed therebetween in the rotation direction R. In other words, the static eliminators 42, the image exposure unit 41, and the static eliminators 42 are disposed in this order along the rotation direction R.

The image exposure unit 41 includes a plurality of light-emitting elements (exposure elements 41a) arranged in the axial direction W. In the following, in order to distinguish between some light-emitting elements, the light-emitting elements that composes the image exposure unit 41 are sometimes referred to as exposure elements 41a. Each exposure element 41a corresponds to one pixel in the image data, and the image exposure unit 41 only need to be provided with the number of the exposure elements 41a corresponding to the pixel size of the image to be formed.

The length in the axial direction W of each static eliminator 42 is made longer than that of the image exposure unit 41. Specifically, the static eliminators 42 are each provided to face the image exposure unit 41 in the rotation direction R, and extend outward beyond both ends of the image exposure unit 41 in the axial direction W. FIG. 2 illustrates the static eliminators 42 that are each long in the axial direction W and connected together as one unit, but the present disclosure is not limited to this, and each static eliminator 42 may include a plurality of light-emitting elements. That is, a plurality of light-emitting elements may be arranged side by side in the axial direction W as each static eliminator 42, and the plurality of light-emitting elements may operate together. In addition, the length of each static eliminator 42 corresponding to the rotation direction R of the photoreceptor drum 3 may be the same as or different from that of each exposure element 41a. When the length of each static eliminator 42 corresponding to the rotation direction R is increased, the time required for static elimination, that is, the static elimination time, can be increased.

In the image forming apparatus 100, the surfaces of the photoreceptor drums 3 are exposed by light emitted from the panel members 12a while the photoreceptor drums 3 are rotated, and when comparing the respective areas of the photoreceptor drums 3 exposed by the image exposure units 41 and the static eliminators 42, the length in the axial direction W is more important than the length in the rotation direction R.

In this embodiment, the static eliminators 42 are longer than the image exposure units 41 in the axial direction W corresponding to the main scanning direction, and together with the image exposure units 41, which are pixel groups that form an image, the static eliminators 42, which have larger areas for exposing the photoreceptor drums 3 than the image exposure units 41, are provided on the same panel members 12a, and therefore the static eliminators 42 can eliminate static to cover portions used for image formation. Therefore, it is possible to reduce the pixel size such that a minimum necessary range is exposed. In addition, the static eliminators 42 and the image exposure units 41 are disposed adjacent to each other, so that the surfaces of the panel members 12a can be efficiently utilized, and the panel members 12a can be made smaller.

In the image forming apparatus 100, regardless of whether the number of sheets of paper is one or multiple, a series of image formation is processed as one job, and static can be eliminated appropriately when the job is completed. The static eliminators 42 may include light-emitting elements of the same specifications as the image exposure units 41, and the output may be controlled such that the exposure light amount for exposure in image formation and the exposure light for static elimination are appropriate.

In each panel member 12a, active matrix wiring may be connected to a plurality of light-emitting elements, and appropriate light-emitting elements may be driven via these wiring. The static eliminators 42 may be controlled together with the image exposure units 41 as one pixel in the active matrix method, or may be wired such that the static eliminators 42 are controlled by a drive circuit separate from the image exposure unit 41.

### Second Embodiment

Now, an image forming apparatus according to a second embodiment of the present disclosure will be described with reference to the drawings. In the second embodiment, a configuration of a panel member 12a is different from that of the first embodiment. The second embodiment has a configuration similar to that of the first embodiment illustrated in FIG. 1 and FIG. 2, and therefore description will be omitted and only the differences will be described.

FIG. 3 is a schematic plan view illustrating the panel member in the second embodiment of the present disclosure.

The second embodiment differs from the first embodiment in arrangement of an image exposure unit 41 and static eliminators 42 in a panel member 12a. Specifically, the static eliminators 42 are disposed adjacent to both ends in the axial direction W of the image exposure unit 41 so as to interpose the image exposure unit 41 therebetween. In this embodiment, the static eliminator 42, the image exposure unit 41, and the static eliminator 42 are disposed in this order along the axial direction W, and in the panel member 12a, a plurality of light-emitting elements are arranged in a row in the axial direction W. In addition, the image exposure unit 41 is controlled such that static is eliminated together with the static eliminators 42. That is, the image exposure unit 41 functions as the static eliminators 42 during static elimination. Thus, the image exposure unit 41 is used in combination with the static eliminators 42, so that a portion where only static elimination is performed can be made as small as possible, and the panel member 12a can be made smaller.

### Third Embodiment

Now, an image forming apparatus according to a third embodiment of the present disclosure will be described with reference to the drawings. In the third embodiment, a configuration of a panel member 12a is different from that of each of the first embodiment and second embodiment. The third embodiment has a configuration substantially similar to that of each of the first embodiment and the second embodiment illustrated in FIG. 1 to FIG. 3, and therefore description will be omitted and only differences will be described.

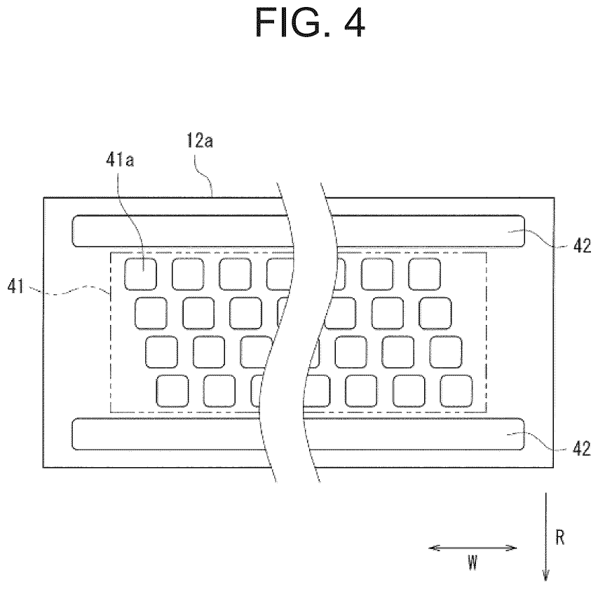

FIG. 4 is a schematic plan view illustrating the panel member in the third embodiment of the present disclosure.

The third embodiment differs from the first embodiment in arrangement of an image exposure unit 41 in the panel member 12a. Specifically, the image exposure unit 41 includes a plurality of rows of exposure elements 41a arranged adjacent to each other in the rotation direction R. That is, in the image exposure unit 41, the plurality of rows of exposure elements 41a arranged in the axial direction W are provided side by side in the rotation direction R (four rows in FIG. 4). Thus, the plurality of rows of light-emitting elements (exposure elements 41a) are provided as the image exposure unit 41, so that exposure can be performed efficiently and processing can be speeded up.

In this embodiment, the static eliminators 42 are provided at two locations with the image exposure unit 41 interposed therebetween in the rotation direction R, as in the first embodiment, and extend outward beyond both ends of the image exposure unit 41 in the axial direction W.

### Fourth Embodiment

Now, an image forming apparatus according to a fourth embodiment of the present disclosure will be described with reference to the drawings. In the fourth embodiment, a configuration of a panel member 12a is different from that of each of the first embodiment to the third embodiment. The fourth embodiment has a configuration substantially similar to that of each of the first embodiment to the third embodiment illustrated in FIG. 1 to FIG. 4, and therefore description will be omitted and only differences will be described.

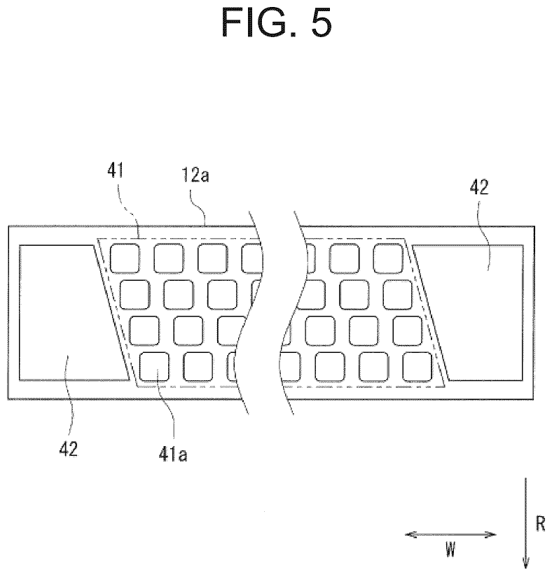

FIG. 5 is a schematic plan view illustrating the panel member in the fourth embodiment of the present disclosure.

The fourth embodiment differs from the third embodiment in arrangement of static eliminators 42 in the panel member 12a. Specifically, the static eliminators 42 are disposed adjacent to both ends in the axial direction W of an image exposure unit 41 so as to interpose the image exposure unit 41 therebetween, just as in the second embodiment. In addition, a range in which the static eliminators 42 are provided in the rotation direction R is substantially the same as that of the image exposure unit 41. FIG. 5 illustrates the static eliminators 42 that are each long in the axial direction W and the rotation direction R, and connected together as one unit, but the present disclosure is not limited to this, a plurality of light-emitting elements may be arranged side by side in the axial direction W and the rotation direction R as each static eliminator 42, and the plurality of light-emitting elements may operate together.

In this embodiment, the image exposure unit 41 is controlled such that static is eliminated together with the static eliminators 42 as in the second embodiment, the image exposure unit 41 functions as the static eliminators 42 during static elimination.

### Fifth Embodiment

Now, an image forming apparatus according to a fifth embodiment of the present disclosure will be described with reference to the drawings. In the fifth embodiment, a configuration of a panel member 12a is different from that of each of the first embodiment to the fourth embodiment. The fifth embodiment has a configuration substantially similar to that of each of the first embodiment to the fourth embodiment illustrated in FIG. 1 to FIG. 5, and therefore description will be omitted and only differences will be described.

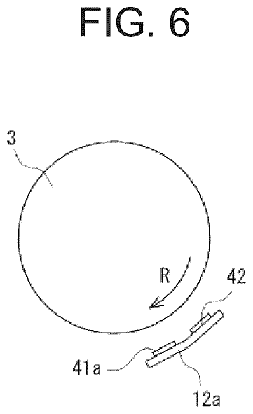

FIG. 6 is a schematic side view illustrating a positional relationship between a photoreceptor drum and a panel member in a fifth embodiment of the present disclosure. In FIG. 6, for ease of viewing, only a photoreceptor drum 3 and the panel member 12a are illustrated out of an image forming apparatus 100.

In the fifth embodiment, in the panel member 12a, a static eliminator 42 and an image exposure unit 41 (exposure element 41a) are disposed adjacent to each other in the rotation direction R, as in the first embodiment and the third embodiment. The panel member 12a is bent such that a surface on which the image exposure unit 41 is provided intersects with a surface on which the static eliminator 42 is provided. Thus, the panel member 12a is bent between the image exposure unit 41 and the static eliminator 42, so that the image exposure unit 41 and the static eliminator 42 can be made to face directly against a peripheral surface of the photoreceptor drum 3.

FIG. 6 simply illustrates the panel member 12a in which a boundary between the image exposure unit 41 and the static eliminator 42 is provided at one location in rotation direction R, but the panel member is not limited to this. In a case where boundaries between the image exposure unit 41 and the static eliminators 42 are provided at two or more locations, a plurality of folds for bending the panel member 12a may be provided. In addition, it is sufficient that the light-emitting elements provided on the panel member 12a face directly against the peripheral surface of the photoreceptor drum 3, and the orientation of the light-emitting elements may be adjusted by curving the panel member 12a so as to fit along the peripheral surface of the photoreceptor drum 3.

The embodiments disclosed herein are illustrative in all respects and are not intended to be a basis for restrictive interpretation. Therefore, the technical scope of the present disclosure should not be interpreted solely by the above embodiments, but should be defined on the basis of the claims. In addition, the present disclosure also includes all modifications within the meaning and scope of the claims.

What is claimed is:

1. An image forming apparatus comprising:
a photoreceptor; and
a panel member that faces the photoreceptor, and has a plurality of light-emitting elements, wherein
the plurality of light-emitting elements include an image exposure unit that exposes the photoreceptor to form an image, and a static eliminator that eliminates static, and
the static eliminator has a larger area for exposing the photoreceptor than the image exposure unit.

2. The image forming apparatus according to claim 1, wherein
the static eliminator has a longer length in an axial direction along a rotation axis of the photoreceptor than the image exposure unit.

3. The image forming apparatus according to claim 2, wherein
the static eliminator and the image exposure unit are disposed adjacent to each other in a direction orthogonal to the axial direction.

4. The image forming apparatus according to claim 3, wherein
the panel member is bent such that a surface on which the image exposure unit is provided intersects with a surface on which the static eliminator is provided.

5. The image forming apparatus according to claim 2, wherein
the static eliminators are disposed adjacent to both ends in the axial direction of the image exposure unit so as to interpose the image exposure unit therebetween, and the image exposure unit eliminates static together with the static eliminators.

6. The image forming apparatus according to claim 2, wherein
the image exposure unit includes a plurality of rows of the light-emitting elements arranged adjacent to each other in a direction orthogonal to the axial direction.
